(19) United States
(12) Patent Application Publication
(10) Pub. No.: US 2022/0138909 A1
(43) Pub. Date: May 5, 2022

(54) NOISE PROCESSING IN IMAGE FRAMES FOR DIGITAL VIDEO

(71) Applicant: QUALCOMM Incorporated, San Diego, CA (US)

(72) Inventors: Prakasha NAYAK, Bangalore (IN); Rahul KUMAR, Hyderabad (IN); Alok Kumar PANDEY, Hyderabad (IN); Rishabh JAIN, Nehtaur Bijnor (IN)

(21) Appl. No.: 17/084,234

(22) Filed: Oct. 29, 2020

(51) Int. Cl. G06T 5/00; G06T 7/00; G06T 5/50

(52) U.S. Cl. CPC G06T 5/002; G06T 7/0002; G06T 2207/20201; G06T 2207/10016; G06T 5/50

(57) ABSTRACT

Aspects relate to noise processing of image frames for video. An example device is configured to perform operations including receiving a sequence of image frames for a digital video, determining an image quality metric of a first image frame from the sequence of image frames, and determining a number of image frames from the sequence of image frames to be blended based on the image quality metric (with the number of image frames including the first image frame). The operations also include blending the number of image frames to generate a blended image frame of the digital video. The image quality metric may include a light intensity metric (such as a luminance metric measured during an autoexposure operation) or a sharpness metric (such as a focus metric measured during an autofocus operation).

### TECHNICAL FIELD

This disclosure relates generally to image or video capture devices, including noise processing across multiple image frames in digital video.

### BACKGROUND

Many devices are configured to capture a sequence of image frames for video. For example, a smartphone, tablet, laptop computer, and other electronic devices include one or more cameras to be used to capture a sequence of frames in generating video. The device also processes each frame after capture, such as to perform remosaicing, color balancing, and other filter operations. The processed frames are combined and encoded to generate the final video.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Some aspects of the present disclosure relate to noise processing of frames for digital video. An example device includes a memory and one or more processors coupled to the memory. The one or more processors are configured to receive a sequence of image frames for a digital video, determine an image quality metric of a first image frame from the sequence of image frames, and determine a number of image frames from the sequence of image frames to be blended based on the image quality metric (with the number of image frames including the first image frame). The one or more processors are also configured to blend the number of image frames to generate a blended image frame of the digital video. The memory is configured to store the blended image frame generated by the one or more processors. The image quality metric may include a light intensity metric (such as a luminance metric measured during an autoexposure operation) or a sharpness metric (such as a focus metric measured during an autofocus operation).

In some implementations, blending the number of image frames includes selecting an anchor frame from the number of image frames and combining each of the other image frames from the number of image frames to the anchor frame to adjust values in the anchor frame. Selecting the anchor frame may be based on a comparison of the image quality metric of each image frame in the number of image frames to one another, or selecting the anchor frame may be based on the most recent frame received.

In some implementations, determining the number of image frames to be blended includes determining that a first number of image frames is to be blended based on the image quality metric being within a first range of image quality metrics and determining that a second number of image frames greater than the first number of image frames is to be blended based on the image quality metric being within a second range of image quality metrics. The sequence of image frames is at a first frame rate greater than a second frame rate of the digital video, a first group of image frames from the sequence of image frames and including the first image frame is associated with the first image frame, the first image frame is the anchor frame, determining the number of image frames includes selecting the image frames from the first group of image frames to be blended, and blending includes combining the selected image frames from the first group of image frames (with the blended image frame associated with the second frame rate). Selecting the image frames may include selecting only the first image frame, with the first image frame used as the blended image frame associated with the second frame rate.

In some implementations of the example device, the one or more processors are further configured to determine a second image quality metric of a second image frame from the sequence of image frames (with the second image quality metric differing from the image quality metric), determine a second number of image frames from the sequence of image frames to be blended based on the second image quality metric, and blend the second number of image frames to generate a second blended image frame of the digital video. The second number of image frames includes the second image frame, and a total of the second number of image frames to be blended differs from a total of the number of image frames to be blended. The one or more processors may also be configured to provide a sequence of blended image frames of the digital video. The sequence of blended image frames includes the blended image frame and the second blended image frame, and the sequence of blended image frames is provided at a constant frame rate.

The device may also include one or more cameras to capture the sequence of image frames. The one or more cameras may include an image sensor configured to capture and readout four image frames from the sequence of image frames in up to eight milliseconds. The device may also include a display to display the digital video.

An example method includes receiving a sequence of image frames for a digital video, determining an image quality metric of a first image frame from the sequence of image frames, and determining a number of image frames from the sequence of image frames to be blended based on the image quality metric (with the number of image frames including the first image frame). The method also includes blending the number of image frames to generate a blended image frame of the digital video. The image quality metric may include a light intensity metric (such as a luminance metric measured during an autoexposure operation) or a sharpness metric (such as a focus metric measured during an autofocus operation).

In some implementations, blending the number of image frames includes selecting an anchor frame from the number of image frames and combining each of the other image frames from the number of image frames to the anchor frame to adjust values in the anchor frame. Selecting the anchor frame may be based on a comparison of the image quality metric of each image frame in the number of image frames to one another, or selecting the anchor frame may be based on the most recent frame received.

In some implementations, determining the number of image frames to be blended includes determining that a first number of image frames is to be blended based on the image quality metric being within a first range of image quality metrics and determining that a second number of image frames greater than the first number of image frames is to be blended based on the image quality metric being within a second range of image quality metrics. The sequence of image frames is at a first frame rate greater than a second frame rate of the digital video, a first group of image frames from the sequence of image frames and including the first image frame is associated with the first image frame, the first image frame is the anchor frame, determining the number of image frames includes selecting the image frames from the first group of image frames to be blended, and blending includes combining the selected image frames from the first group of image frames (with the blended image frame associated with the second frame rate). Selecting the image frames may include selecting only the first image frame, with the first image frame used as the blended image frame associated with the second frame rate.

In some implementations, the method also includes determining a second image quality metric of a second image frame from the sequence of image frames (with the second image quality metric differing from the image quality metric), determining a second number of image frames from the sequence of image frames to be blended based on the second image quality metric, and blending the second number of image frames to generate a second blended image frame of the digital video. The second number of image frames includes the second image frame, and a total of the second number of image frames to be blended differs from a total of the number of image frames to be blended. The method may also include providing a sequence of blended image frames of the digital video. The sequence of blended image frames includes the blended image frame and the second blended image frame, and the sequence of blended image frames is provided at a constant frame rate.

In some implementations, the sequence of image frames are captured by an image sensor configured to capture and readout four image frames from the sequence of image frames in up to eight milliseconds.

An example non-transitory, computer-readable medium stores instructions that, when executed by one or more processors of a device, cause the device to receive a sequence of image frames for a digital video, determine an image quality metric of a first image frame from the sequence of image frames, and determine a number of image frames from the sequence of image frames to be blended based on the image quality metric (with the number of image frames including the first image frame). Execution of the instructions may also cause the device to blend the number of image frames to generate a blended image frame of the digital video. The image quality metric may include a light intensity metric (such as a luminance metric measured during an autoexposure operation) or a sharpness metric (such as a focus metric measured during an autofocus operation).

In some implementations, blending the number of image frames includes selecting an anchor frame from the number of image frames and combining each of the other image frames from the number of image frames to the anchor frame to adjust values in the anchor frame. Selecting the anchor frame may be based on a comparison of the image quality metric of each image frame in the number of image frames to one another, or selecting the anchor frame may be based on the most recent frame received.

In some implementations, determining the number of image frames to be blended includes determining that a first number of image frames is to be blended based on the image quality metric being within a first range of image quality metrics and determining that a second number of image frames greater than the first number of image frames is to be blended based on the image quality metric being within a second range of image quality metrics. The sequence of image frames is at a first frame rate greater than a second frame rate of the digital video, a first group of image frames from the sequence of image frames and including the first image frame is associated with the first image frame, the first image frame is the anchor frame, determining the number of image frames includes selecting the image frames from the first group of image frames to be blended, and blending includes combining the selected image frames from the first group of image frames (with the blended image frame associated with the second frame rate). Selecting the image frames may include selecting only the first image frame, with the first image frame used as the blended image frame associated with the second frame rate.

In some implementations, execution of the instructions also causes the device to determine a second image quality metric of a second image frame from the sequence of image frames (with the second image quality metric differing from the image quality metric), determine a second number of image frames from the sequence of image frames to be blended based on the second image quality metric, and blend the second number of image frames to generate a second blended image frame of the digital video. The second number of image frames includes the second image frame, and a total of the second number of image frames to be blended differs from a total of the number of image frames to be blended. Execution of the instructions may also cause the device to provide a sequence of blended image frames of the digital video. The sequence of blended image frames includes the blended image frame and the second blended image frame, and the sequence of blended image frames is provided at a constant frame rate.

In some implementations, the sequence of image frames are captured by an image sensor configured to capture and readout four image frames from the sequence of image frames in up to eight milliseconds.

Another example device includes means for receiving a sequence of image frames for a digital video, means for determining an image quality metric of a first image frame from the sequence of image frames, and means for determining, from the sequence of image frames, a number of image frames to be blended for the first image frame based on the image quality metric (with the number of image frames including the first image frame). The device also includes means for blending the number of image frames to generate a final image frame of the digital video. The image quality metric may include a light intensity metric (such as a luminance metric measured during an autoexposure operation) or a sharpness metric (such as a focus metric measured during an autofocus operation).

In some implementations, blending the number of image frames includes selecting an anchor frame from the number of image frames and combining each of the other image frames from the number of image frames to the anchor frame to adjust values in the anchor frame. Selecting the anchor frame may be based on a comparison of the image quality metric of each image frame in the number of image frames to one another, or selecting the anchor frame may be based on the most recent frame received.

In some implementations, determining the number of image frames to be blended includes determining that a first number of image frames is to be blended based on the image quality metric being within a first range of image quality metrics and determining that a second number of image frames greater than the first number of image frames is to be blended based on the image quality metric being within a second range of image quality metrics. The sequence of image frames is at a first frame rate greater than a second frame rate of the digital video, a first group of image frames from the sequence of image frames and including the first image frame is associated with the first image frame, the first image frame is the anchor frame, determining the number of image frames includes selecting the image frames from the first group of image frames to be blended, and blending includes combining the selected image frames from the first group of image frames (with the blended image frame associated with the second frame rate). Selecting the image frames may include selecting only the first image frame, with the first image frame used as the blended image frame associated with the second frame rate.

In some implementations, the device also includes means for determining a second image quality metric of a second image frame from the sequence of image frames (with the second image quality metric differing from the image quality metric), means for determining a second number of image frames from the sequence of image frames to be blended based on the second image quality metric, and means for blending the second number of image frames to generate a second blended image frame of the digital video. The second number of image frames includes the second image frame, and a total of the second number of image frames to be blended differs from a total of the number of image frames to be blended. The device may also include means for providing a sequence of blended image frames of the digital video. The sequence of blended image frames includes the blended image frame and the second blended image frame, and the sequence of blended image frames is provided at a constant frame rate.

In some implementations, the sequence of image frames are captured by an image sensor configured to capture and readout four image frames from the sequence of image frames in up to eight milliseconds.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is a block diagram of an example device for processing image frames for video.

FIG. 2 is an illustrative flow chart depicting an example operation for processing image frames for video.

FIG. 3 is a timing diagram of image frames of a sequence being readout at a constant rate.

FIG. 4 is a timing diagram of image frames of a sequence received in batches associated with different blended image frames for video.

FIG. 5 is a timing diagram of image frames of a sequence received from a camera including a fast readout sensor.

### DETAILED DESCRIPTION

Aspects of the present disclosure may be used for image capture and processing devices. Some aspects include noise processing of image frames for a digital video.

A camera captures a sequence of image frames for capturing a video. One or more of the image frames may include noise as a result of the environment or other conditions. For example, during low light conditions (such as while indoors or at night), the exposure window for each frame being captured is lengthened, and the lengthened exposure window may cause a blur in the image frame from one or more objects in the scene moving (referred to as local motion) or from the camera moving (referred to as global motion) during the exposure window.

A device may process the sequence of image frames to attempt to reduce the noise. For example, a device may perform motion compensated temporal filtering (MCTF) on the sequence of image frames. In performing MCTF, the device aligns the content in a previous image frame and a current image frame (such as objects in the scene captured in both frames), blends the current frame and the previous frame to generate a combined frame, and stores the combined frame for the final video.

A problem with current MCTF techniques is that the number of frames to be blended is static. In extreme conditions (such as very low light), image quality could be improved by increasing the number of frames to be blended together because of increased noise resulting from the extreme conditions, but the current filtering techniques define a static number of image frames (such as two) to be blended. Conversely, in less extreme conditions (such as bright light and daytime scenarios for image capture), noise may be significantly reduced or non-existent in the image frames such that blending is not required. However, the current filtering techniques require the static number of image frames to be blended (thus requiring processing resources and time when such filtering is not needed).

In some implementations, a device is configured to adjust the number of image frames to be blended based on an image quality metric. For example, a light intensity metric (such as a scene luminance determined during an autoexposure operation) or a sharpness metric (such as a focus metric determined during an autofocus operation) may be used to determine the number of image frames to be blended in generating a blended image frame for a video. In this manner, the number of image frames to be blended may be reduced in good conditions (such as scenes with bright ambient lighting and little to no movement in the scene or by the camera), and the number of image frames may be increased as the conditions deteriorate (such as the ambient light decreasing or global or local motion increasing to cause a light intensity metric or a sharpness metric to change during video capture). As a result, the number of frames to be blended may be adjusted as needed to balance improving image quality versus the processing, power, and time costs in performing operations for blending.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure. Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any suitable electronic device capable of performing image processing. The device may include or be coupled to one or more image sensors capable of capturing image frames (also referred to as frames) for video (such as security systems, smartphones, tablets, laptop computers, digital video cameras, and so on). However, aspects of the present disclosure may be implemented in devices having or coupled to no image sensors (such as devices receiving a previously captured sequence of image frames to be processed from a memory or another device).

The terms “device” and “apparatus” are not limited to one or a specific number of physical objects (such as one smartphone, one camera controller, one processing system and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

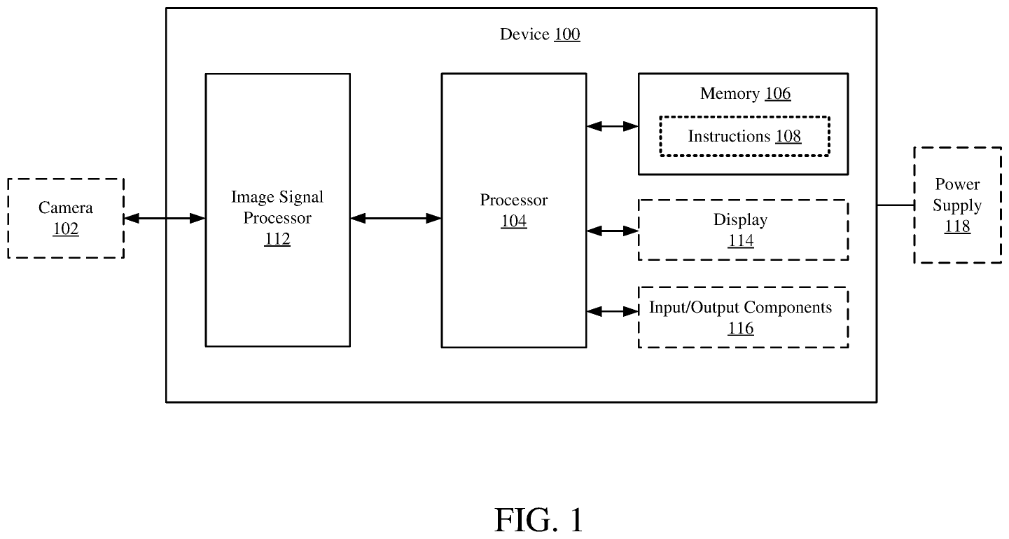

FIG. 1 is a block diagram of an example device 100 for processing image frames for video. The device includes a processor 104, a memory 106 storing instructions 108, and an image signal processor 112. In some implementations, the example device 100 also includes or is coupled to a camera 102, a display 114, one or more input/output (I/O) components 116, and a power supply 118 (such as a battery or a component to couple the device 100 to an energy source). The device 100 may include or be coupled to additional features or components not shown. In one example, a wireless interface, which may include a number of transceivers and a baseband processor, may be included for a wireless communication device. In another example, one or more sensors (such as a gyroscope or a global positioning system (GPS) receiver) may be included in or coupled to the device. In a further example, an analog front end to convert analog image frame data to digital image frame data may be coupled between the camera 102 and the image signal processor 112.

The camera 102 is configured to capture a sequence of image frames for video capture. The camera 102 may include one or more image sensors, one or more lenses for focusing light, one or more apertures for receiving light, one or more shutters for blocking light when outside an exposure window, one or more color filter arrays (CFAs) for filtering light outside of specific frequency ranges, one or more analog front ends for converting analog measurements to digital information, or other suitable components for imaging. The device 100 may also include a flash, a depth sensor, a GPS, or other suitable components for imaging. While FIG. 1 illustrates the example device 100 as possibly including one camera 102 coupled to the image signal processor 112, any number of cameras may be coupled to the image signal processor 112 (including zero, for which the device receives a sequence of image frames from a memory (such as memory 106) or another device).

The image signal processor 112 includes one or more processors to process the image frames captured by the camera 102. Processing image frames may include color balancing, denoising, edge enhancement, remosaicing, and other filters to improve the image quality for the video. In some implementations, aspects of the present disclosure are implemented in the image signal processor 112 for noise processing of the image frames. In some other implementations, aspects of the present disclosure may be implemented in the processor 104 (which may include one or more applications processors or other suitable processors) or implemented in a combination of the image signal processor 112 and the processor 104.

The image signal processor 112 may also provide processed image frames to the memory 106 for storage. For example, the image signal processor 112 may perform noise processing on a sequence of image frames (such as blending image frames to generate a blended image frame for the video) or apply other processing filters to the received image frames to generate processed image frames for a video, and the image signal processor 112 may provide the processed image frames to the memory 106 to be stored. In some aspects, the image signal processor 112 may execute instructions from a memory (such as instructions 108 from the memory 106, instructions stored in a separate memory coupled to or included in the image signal processor 112, or instructions provided by the processor 104). In addition or alternative to the image signal processor 112 configured to execute software, the image signal processor 112 may include specific hardware (such as one or more integrated circuits (ICs)) to perform one or more operations described in the present disclosure.

The device 100 may also include a memory 106. The memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100 (such as an operating system and specific applications other than for image or video generation). For example, execution of a camera application (such as by the processor 104) may cause the device 100 to generate a sequence of images for video using the camera 102 and the image signal processor 112. The memory 106 may be accessed by the image signal processor 112 to store processed frames or may be accessed by the processor 104 to obtain the processed frames.

The device 100 may also include a processor 104. The processor 104 may include one or more general purpose processors capable of executing scripts or instructions of one or more software programs (such as instructions 108) stored within the memory 106. For example, the processor 104 may include one or more application processors configured to execute a camera application (or other suitable application for generating images or video) stored in the memory 106. In executing the camera application, the processor 104 may be configured to instruct the image signal processor 112 to perform one or more operations with reference to the camera 102. Execution of instructions 108 outside of the camera application by the processor 104 may also cause the device 100 to perform any number of functions or operations. In some implementations, the processor 104 may include ICs or other hardware in addition to the ability to execute software to cause the device 100 to perform a number of functions or operations (including the operations described herein). In addition or alternative to the image signal processor 112 performing aspects of the present disclosure, the processor 104 may perform noise processing on the sequence of image frames to output the blended image frames for a video. For example, the image signal processor 112 may receive image frames from the camera 102, process the image frames (such as performing remosaicing, color balancing, edge enhancement, and so on), and provide the processed image frames to the memory 106. The processor 104 may retrieve the processed image frames from the memory 106 and perform noise processing on the retrieved image frames (such as blending or other processes described in the present disclosure) to generate the final image frames for the video. In a different example, the image signal processor 112 may perform the noise processing to generate the final image frames for the video and provide the final image frames to the memory 106. The processor 104 may retrieve the final image frames from the memory 106 and encode the final image frames for the video. While the present disclosure describes aspects of the disclosure as being performed by the processor 104 or the image signal processor 112 for clarity, any suitable device components may be used to perform aspects of the present disclosure.

In some implementations, the device 100 includes a display 114. The display 114 may include one or more suitable displays or screens allowing for user interaction and/or to present items to the user (such as a preview of the image frames being captured by the camera 102 or the video generated by the device 100). In some aspects, the display 114 is a touch-sensitive display. The device 100 may also include I/O components 116, and the I/O components 116 may be or include any suitable mechanism, interface, or device to receive input (such as commands) from the user and to provide output to the user. For example, the I/O components 116 may include a graphical user interface (GUI), keyboard, mouse, microphone and speakers, a squeezable bezel, one or more buttons (such as a power button), a slider or switch, and so on.

While shown to be coupled to each other via the processor 104 in the example of FIG. 1, the processor 104, the memory 106, the image signal processor 112, the display 114, and the I/O components 116 may be coupled to one another in various arrangements. For example, the processor 104, the memory 106, the image signal processor 112, the display 114, and/or the I/O components 116 may be coupled to each other via one or more local buses (not shown for simplicity). In another example, while the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, number of components, or combinations of components may be included in a suitable device for performing aspects of the present disclosure. As such, the present disclosure is not limited to a specific device or configuration of components, including the device 100.

Two or more frames may be aligned and blended for noise processing to generate a final frame for a video. Each image frame may be an array of image pixels of X rows and Y columns, and each image pixel (x,y) for x in X and y in Y includes a pixel value (such as YUV values, RGB values, Y′CbCr, or any other suitable units for indicating a pixel value). Aligning an image frame to another image frame may include moving the positions of the pixel values to different image pixels. For example, the image frame may be shifted, rotated, stretched, pinched, or otherwise adjusted to move one or more pixel values to different image pixel positions. After two image frames are aligned, the positions of objects are at the same pixel positions in the first image frame and the second image frame. In this manner, image pixel (x,y) in the first image frame corresponds to image pixel (x,y) in the second image frame. Temporal blending refers to combining the pixel values of image pixel (x,y) in the first and second image frames. In some examples, blending may include averaging, determining a median, or other means for combining the pixel values.

In some implementations, blending (after alignment) includes selecting one image frame from a group of image frames as an anchor frame. Each pixel value of the anchor frame is used as a baseline pixel value for the image pixel position. For each image pixel position in the anchor frame, the pixel values from the non-anchor frames are used to adjust the pixel value from the anchor frame. For example, a weighted average of the pixel values may be performed with the anchor frame's pixel value having a higher weighting than non-anchor frames' pixel values. However, any suitable adjustment of the anchor frame's pixel values may be performed during blending of the anchor frame and the non-anchor frames.

As noted above, MCTF defines a static number of image frames to be blended. In this manner, the same number of image frames are blended even if scene conditions change, such as changes in ambient lighting, depth, amount of global or local motion, and so on. For example, if two image frames are blended for image frames captured in low light conditions, two image frames are also blended for image frames captured in bright light conditions. As a result, for image frames captured in low light conditions, image quality of a final image frame may be less than desired than if the number of image frames to be blended is increased, and for image frames captured in bright light conditions, processing resources required for blending may be greater than desired than if the number of image frames to be blended is decreased (which may include decreasing the number of image frames to be blended to one so that no blending is performed).

In some implementations of the present disclosure, a device is configured to adjust the number of image frames to be blended to generate the blended image frames for a video (which the blended image frames may be the final image frames of the video are may be further processed to generate the final image frames). For example, the device may determine the number of image frames to be blended, obtain the determined number of image frames (such as from a camera or a memory), and blend the obtained image frames to generate a blended image frame for the video. Determining the number of image frames to be blended is based on one or more image quality metrics. As used herein, an image quality metric is a measurement of any condition that may affect the image quality of an image frame. An example image quality metric includes a measurement of light intensity in the image frame (such as a luma measurement of an image frame or of a scene being captured in the image frame), a measurement of sharpness in the image frame (such as a contrast measurement for contrast detection autofocus (CDAF) or a phase difference measurement for phase detection autofocus (PDAF)), a measurement of color tinting in the image frame, a measurement of the color of the ambient lighting (such as a measurement in Kelvins to indicate whether the lighting is warm or cool, indoors or outdoors, may cause shadows, and so on), a count of the number of light sources lighting the scene for image capture, a measurement of camera movement from a GPS, a motion sensor, or other device sensor, or other suitable metrics that may impact the image quality. While a light intensity metric and a sharpness metric are used as example image quality metrics in the examples described below, any suitable image quality metric (or combination of image quality metrics) may be used.

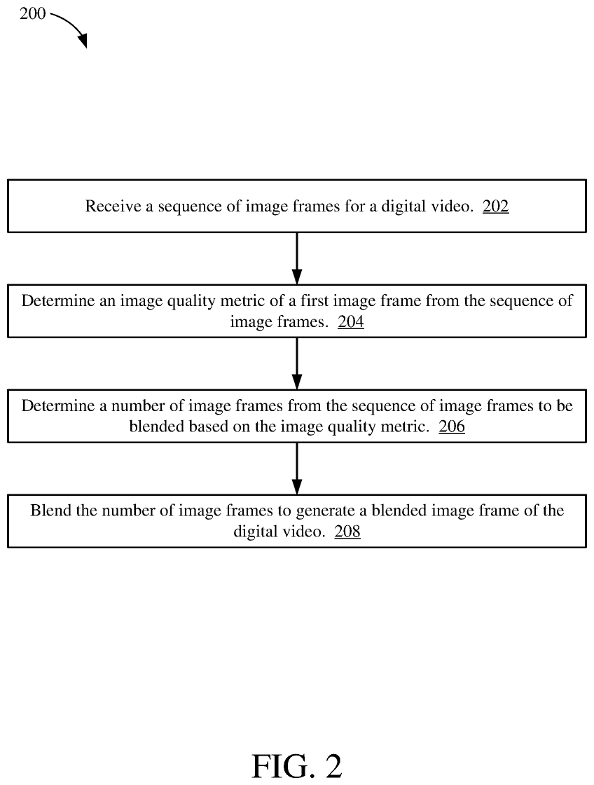

FIG. 2 is an illustrative flow chart depicting an example operation 200 for processing image frames for video. The operation 200 may be performed by the example device 100 in FIG. 1 (such as by the image signal processor 112 and/or the processor 104). While the example operation 200 and the other examples are described as being performed by the device 100, any suitable device, device component, or combination of device components may perform the operations described.

At 202, the device 100 receives a sequence of image frames for a digital video. In some implementations, the camera 102 may capture the sequence of image frames and provide the sequence of image frames to the image signal processor 112 (such as after being converted from analog values to digital values via an analog front end). The image signal processor 112 may receive the sequence of image frames to perform the example operation 200. The device 100 may include a buffer or other suitable memory for temporarily storing a plurality of image frames recently received. For example, the image signal processor 112 may be coupled to or include a buffer storing a plurality of image frames, and each frame stored in the buffer may be accessed out of order by the image signal processor 112. In another example, the buffer may be a first in first out (FIFO buffer). In this manner, the sequence of image frames including a number of image frames to be blended may be stored in the buffer. In some implementations, the size of the buffer is at least a size needed to store the maximum number of image frames that may be blended. For example, if the device 100 is configured to blend a maximum of five image frames for any blended image frame of the video, the buffer is configured to store at least five image frames.

In some other implementations, the image signal processor 112 applies other processing filters to the sequence of image frames (such as blurring, remosaicing, edge enhancement, color balancing, and so on). The image signal processor 112 may then provide the sequence of image frames after processing to the memory 106. The processor 104 may access the memory 106 and receive the sequence of image frames to perform the example operation 200.

At 204, the device determines an image quality metric of a first image frame from the sequence of image frames. As noted above, the image quality metric may be one or more metrics measured by the device 100 of a condition that may affect the image quality of an image frame. For example, the image quality metric may include a light intensity metric (such as a luminance metric measured during an autoexposure operation) or a sharpness metric (such as a focus metric measured during an autofocus operation). Example image quality metrics are described in more detail in the below examples.

The first image frame from the sequence may be at any position in the sequence of image frames. For example, the first image frame may be the frame at the pth position in the sequence of P frames (where integer p<integer P). The first image frame may include the first image frame of a number of image frames to be blended, may include the last image frame of the number of image frames to be blended, may include the image frame at a defined interval of image frames in the sequence, may include the image frame determined based on one or more image quality metrics associated with the frame, or may include any other suitable image frame from the sequence.

At 206, the device 100 determines a number of image frames from the sequence of image frames to be blended based on the image quality metric. The number of image frames may include the first image frame (from which the image quality metric is determined). At 208, the device 100 blends the number of image frames to generate a blended image frame of the digital video. While not shown, the blended image frame may be provided to the memory 106 for storage or otherwise used in generating the final digital video. Also while not shown, the blended image frame may be further processed (such as additional filters being applied to the blended frame, the blended frame being encoded, and so on) to generate a final image frame of the digital video. In some other implementations, the blended image frame may be the final image frame of the digital video.

How many image frames are included in the number of image frames may be greater than or equal to one. In some implementations of determining how many frames to be blended, the device 100 determines an image quality metric (such as from the first image frame) and compares the image quality metric to one or more thresholds to determine a range into which the image quality metric falls. For example, if the image quality metric is a luminance metric measured in luma, the luma value of the luminance metric may be compared to a lower threshold and an upper threshold (breaking the spectrum of luma into three ranges, such as an upper range of bright light conditions, a middle range of light conditions, and a lower range of low light conditions). Each range may be associated with a different number of image frames to be blended. For example, an upper range of bright light conditions may be associated with a number of one. In this manner, no frames are blended to generate a blended image frame (in other words, the first image frame may be the blended image frame for the video). The light conditions may be determined to be great enough such that blending may not be sufficiently helpful in improving image quality compared to the processing costs associated with blending. A middle range of light conditions may be associated with a number of two. In this manner, two frames may be blended together to generate a blended image frame. A lower range of low light conditions may be associated with a number of three. In this manner, three frames may be blended together to generate a blended image frame. In the example, the number of frames to be blended increases as the light intensity metric decreases (indicating less lighting in the scene).

While two thresholds, three ranges, and numbers of 1, 2, and 3 image frames for blending for the different ranges of a light intensity metric are provided in the example, any number of thresholds, number of ranges, number of image frames to be blended for each range, or image quality metric to be used may be any suitable value or metric. In addition, the thresholds may be static or dynamic. For example, the thresholds or the number of frames to be blended may be adjusted during a calibration or over time as more blended image frames' image qualities may be compared to determine better thresholds or better number of frames for blending. In another example, example blended image frames may be displayed to a user, and a user may indicate or adjust (such as via a GUI or other I/O component) the thresholds or the number of frames to be blended based on the user's observations of the example image frames displayed. Any other suitable means for adjusting the thresholds or the number of image frames may be performed, and the present disclosure is not limited to a specific example.

The example operation 200 in FIG. 2 may apply to a variety of image frames captured by different types of cameras. In some implementations, camera 102 may be configured to capture frames at 30 frames per second (fps), 60 fps, 24 fps or another frame rate that is the same as the frame rate of the final video. For image frames being provided by the camera 102 at a rate of 30 fps, an image frame may be provided approximately every 33 ms.

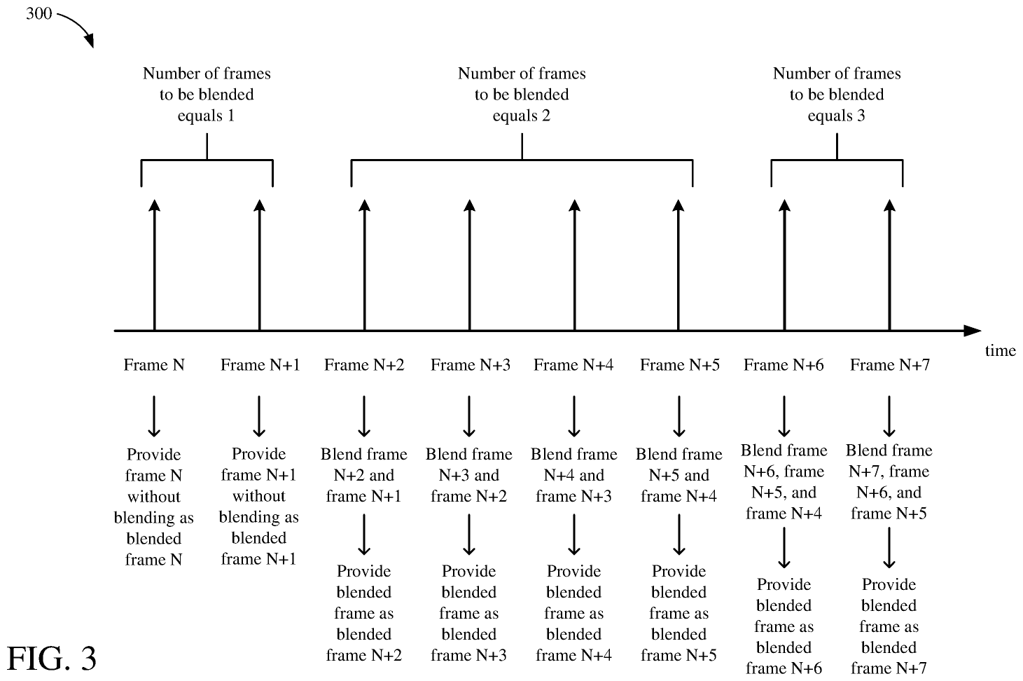

In general for a sequence of image frames, the device 100 is configured to adaptively determine the number of image frames to be blended and blend the different number of image frames for different portions of the sequence. For example, while not shown in FIG. 2, the device 100 may determine a second image quality metric of a second image frame from the sequence of image frames (with the second image quality metric differing from the image quality metric determined in 204). The device 100 may also determine a second number of image frames from the sequence of image frames to be blended based on the second image quality metric and blend the second number of image frames to generate a second blended image frame of the digital video. The second number of image frames includes the second image frame, and a total of the second number of image frames to be blended differs from a total of the number of image frames to be blended. For example, the number of image frames determined in 206 may be three image frames from the sequence, and the second number of image frames may be 1, 2, or 4 or more image frames from the sequence. In some implementations, no matter the number of image frames to be blended, the blended frames may be provided at a constant frame rate associated with a digital video's constant frame rate. FIGS. 3-5 illustrate examples of adaptively determining a number of image frames to be blended and blending the different number of image frames for different portions of a sequence of image frames for a digital video.

FIG. 3 is a timing diagram 300 of image frames N to N+7 of a sequence being received (such as being readout by camera 102) at a constant frame rate. The frame rate may be 24 fps, 30 fps, 60 fps, or another suitable frame rate. In the example, the frame rate at which the sequence of image frames is received may be the same as the frame rate of the final video. In this manner, each image frame corresponds to a final image frame in the video. In the example, the device 100 determines that, for frames N and N+1 of a sequence of P frames received (where N is an integer greater than or equal to 1 and less than or equal to P−7), the number of frames to be blended equals 1. The device 100 also determines that, for frames N+2 to N+5, the number of frames to be blended equals 2. The device 100 also determines that, for frames N+6 and N+7, the number of frames to be blended equals 3. If the maximum number of image frames that may be blended together is 3, the device 100 may include a buffer to store the last 3 or more image frames received. In the example, blending includes combining a current frame with up to 2 frames preceding the current frame. For example, blending 3 frames for image frame N+6 includes blending frames N+4, N+5, and N+6.

If the image signal processor 112 is configured to perform the blending, the image signal processor 112 provides frame N as blended frame N for the video and provides frame N+1 as blended frame N for the video without blending (since the number of frames to be blended equals 1). In the example, a buffer may store frame N and frames N−1 and N−2 (if N is greater than 2) based on the maximum number of frames to be blended being three. In this manner, if the image signal processor 112 were to blend two or more frames for image frame N, the two or more frames (including image frame N) stored in the buffer would be blended, and the blended image frame would be provided as the blended image frame for the video. When frame N+1 is received and the buffer stores three image frames, the buffer may drop frame N−2 (which is the oldest image frame stored in the buffer and not to be blended with the current image frame).

Proceeding to receiving frame N+2, the device 100 determines that the number of frames to be blended equals 2. In this manner, the image signal processor 112 may blend frames N+2 and N+1 stored in the buffer and provide the blended frame as blended frame N+2 for the video. For frame N+3, the image signal processor 112 may blend frames N+3 and N+2 stored in the buffer and provide the blended frame as blended frame N+3 for the video. For frame N+4, the image signal processor 112 may blend frames N+4 and N+3 stored in the buffer and provide the blended frame as blended frame N+4 for the video. For frame N+5, the image signal processor 112 may blend frames N+5 and N+4 stored in the buffer and provide the blended frame as blended frame N+5 for the video. For frame N+6, the device 100 determines that the number of frames to be blended equals 3. In this manner, the image signal processor 112 may blend frames N+6, N+5, and N+4 stored in the buffer and provide the blended frame as blended frame N+6 for the video. For frame N+7, the image signal processor 112 may blend frames N+7, N+6, and N+5 stored in the buffer and provide the blended frame as blended frame N+7 for the video.

As noted above, determining the number of frames to be blended may be based on one or more image quality metrics (such as a light intensity metric or a sharpness metric). The one or more image quality metrics may be determined from the current frame, or the one or more image quality metrics may be the most recent measurement since receiving the current frame. In some implementations, the image quality metric is a light intensity metric. In one example, the device 100 (such as the image signal processor 112) may determine a total luminance in a current image frame (such as a summation of luminous flux (lux) across the pixel values of the image frame). For example, a luma component Y of YUV values may be added for all pixel values of the image frame to generate a total luminance value.

In another example, the camera 102 and/or the device 100 performs an autoexposure operation periodically during operation of the camera 102 (such as every frame, every batch of frames, or another suitable interval of frames captured by the camera 102). In some implementations, light information captured by the image sensor of the camera 102 may be used during an autoexposure operation to determine a luminance metric, and the luminance metric may be used as the light intensity metric for determining the number of image frames to be blended. In some other implementations, the device 100 may include a separate light sensor or a separate image sensor that operates concurrently with the camera 102 to capture light information (which may include capturing a separate image) for the autoexposure operation to determine the luminance metric.

An autoexposure operation is configured for many devices to determine a luminance metric, and the luminance metric is used to determine an exposure window length. For example, mobile device operating systems include camera applications with a defined autoexposure operations library that, when executed, outputs a luminance metric measured during the autoexposure operations performed (which may be measured in lux or another suitable unit and indicate a brightness in the scene for image capture). For example, when the camera application is being executed and the camera 102 is active, the device 100 executing the camera application periodically determines the luminance metric. In this manner, the device 100 may use the existing luminance metric instead of determining a separate light intensity metric for determining the number of frames to be blended.

As a luminance metric decreases (indicating ambient light is decreasing, such as when the sun sets or the camera 102 moving indoors), the number of frames to be blended increases. For example, if up to three frames are to be blended, a first threshold indicates whether the number of image frames to be blended is one (for which the luminance metric is greater than the first threshold, indicating that the current frame is not to be blended with any other frames) or more than one (for which the luminance metric is less than the first threshold, indicating that at least one preceding frame is blended with the current frame). Similarly, a second threshold (lower than the first threshold) indicates whether the number of image frames to be blended is two or three. In this manner, the device 100 may compare the luminance metric (or any other suitable light intensity metric) to one or more thresholds to determine the number of frames to be blended. The device 100 may determine that a first number of image frames is to be blended based on the image quality metric (such as the luminance metric) being within a first range of image quality metrics, and the device 100 may determine that a second number of image frames greater than the first number of image frames is to be blended based on the image quality metric being within a second range of image quality metrics. For example, a luminance metric associated with frame N may be within a first range, and a luminance metric associated with frame N+2 may be within a second range.

In the example in FIG. 3, the number of frames to be blended increases as the sequence of frames progresses, which may indicate that the luminance metric is decreasing. The luminance metric decreasing may correspond to the exposure windows lengthening and more blur or other noise possibly occurring in the image frames as a result of the lengthened exposure windows. In this manner, using more image frames for blending may assist in reducing the increased blur or noise occurring in the image frames as a result of the lengthened exposure windows.

In addition or alternative to a light intensity metric, an image quality metric may include a sharpness metric. For example, as objects in a scene move faster or the camera 102 moves faster based on a same length exposure window (such as cars moving through the scene for local motion or a user's hand shaking while holding the camera 102), objects in an image frame may appear blurrier. To compensate for the increased blur in an image frame, the number of image frames to be blended may be increased. A sharpness metric may be any suitable metric (such as an edge detection measurement, a contrast measurement, and so on).

In some implementations, the sharpness metric is a focus metric determined during an autofocus operation. For example, the camera application may include a defined autofocus operations library that, when executed, outputs a focus metric measured during the autofocus operations performed. In one example, the device 100 may be configured to perform CDAF when executing the camera application and the camera 102 is active. In this manner, the focus metric may be a contrast determined based on pixel values for a region of interest (ROI) within the camera's field of view for an image frame. In another example, the device 100 may be configured to perform PDAF when executing the camera application and the camera 102 is active. In this manner, the focus metric may be a phase difference measured. In some implementations, CDAF or PDAF may be performed using the image sensor of the camera 102 (such as based on one or more image frames from the camera 102). In some other implementations, CDAF or PDAF may be performed using a separate image sensor (such as a lower resolution sensor separate from the camera 102). A contrast metric increasing or a phase difference decreasing corresponds to a scene becoming less blurry in one or more image frames (which may be referred to as becoming more in focus).

As a focus metric changes so that a scene becomes blurrier (such as the contrast decreasing or the phase difference increasing), the number of frames to be blended increases. For example, if up to three frames are to be blended, a first threshold indicates whether the number of image frames to be blended is one or more than one. Similarly, a second threshold indicates whether the number of image frames to be blended is two or three. In this manner, the device 100 may compare the focus metric (or any other suitable sharpness metric) to one or more thresholds to determine the number of frames to be blended. The device 100 may thus determine if the focus metric is within a range of one or more ranges of focus metrics.

In the example in FIG. 3, the number of frames to be blended increases as the sequence of frames progresses, which may indicate that the focus metric is changing such that the scene becomes blurrier in the image frames over the sequence of image frames. The focus metric changing may correspond to the camera 102 moving more than before (such as from panning or shaking the camera 102) or objects in the scene moving faster. In this manner, using more image frames for blending may assist in reducing the increased blur or noise occurring in the image frames as a result of the increased movement.

As noted above, blending may include determining the anchor frame. Blending may also include determining which non-anchor frames to blend with the anchor frame in addition to combining the pixel values to generate a blended image frame. The anchor frame may be determined in any suitable manner. In some implementations, the device 100 determines the most recent image frame received to be the anchor frame. In some other implementations, the device 100 may determine the anchor frame to be the image frame with the best image quality metric. For example, the device 100 may determine the image frame in the buffer including the best light intensity metric, sharpness metric, or other suitable image quality metric. In some other implementations, a user may preview the image frames and select the anchor frame.

The image frames in the sequence to be blended with the anchor frame may be determined based on one or more of their temporal proximity to the anchor frame or their associated image quality metric. In some implementations, image frames that neighbor the anchor frame in the sequence may be preferred over non-neighboring image frames to the anchor frame for blending. In this manner, less time exists between the capture of frames to be blended, reducing the number of artifacts that may occur as a result of the time difference. For example, if the anchor frame is the current frame received, one or more frames to be blended with the anchor frame includes one or more neighboring frames immediately preceding the current frame. If the anchor frame is not the current frame received, one or more frames to be blended with the anchor frame includes one or more neighboring frames immediately preceding and/or succeeding the current frame.

In addition or alternative to determining frames for blending based on their temporal proximity to the anchor frame, determining the non-anchor frames for blending may be based on one or more image quality metrics of the frames. For example, if the image quality metric is a luminance metric, the image frames in the buffer associated with the highest luminance metric as compared to one another may be selected for being blended with the anchor. In this manner, an image frame that may be associated with poor lighting or transient noise not affecting other frames in the sequence may be prevented from being used for blending. In another example, determining the frames for blending may be based on a combination of the temporal proximity of the frame and an image quality metric associated with the frame. For example, a weighted vote checker may be used to measure temporal proximity and image quality together to compare multiple frames to be selected from for the non-anchor frames for blending. In a further example, temporal proximity may be used to select the frames for blending, and an image quality metric may be used to adjust the impact of each selected frame during the blending process. As noted above, blending the frames together may include combining each of the non-anchor frames to the anchor frame to adjust values in the anchor frame. In this manner, the anchor frame may be a reference frame or baseline frame, and one or more pixel values of the anchor frame may be adjusted based on the associated pixel values in the one or more non-anchor frames.

An anchor frame selected for generating a previous blended frame may be selected as an anchor frame for a current blended frame or a non-anchor frame for blending with a different anchor frame for the current blended frame of the video. For example, frame N+1 in FIG. 3 may be the anchor frame for generating blended frame N+1 and may be a non-anchor frame for blending with frame N+2 for generating blended frame N+2. In this manner, operations of determining anchor frames, determining which frames to blend, and so on to generate previous blended frames may not impact operations to generate succeeding blended frames. In some implementations, though, previous operations and the resulting blended image frames may be used in determining whether to adjust the number of image frames to be blended (such as by adjusting the thresholds or number of thresholds for one or more image quality metrics). While some examples are provided for determining the anchor frame and for determining the image frames to be blended with the anchor frame, any suitable manner in determining the anchor frame and in determining the image frames to be blended with the anchor frame may be performed.

While the example illustrated in FIG. 3 and described above is with reference to the camera frame rate that is the same as the video frame rate, the camera frame rate may be greater than the video frame rate. In some implementations, the device 100 may perform the operations described above with reference to FIG. 3 for a portion of the image frames in the sequence. For example, camera 102 may have a frame rate of 60 fps and the video's frame rate may be 30 fps. For every other frame in the sequence, the device 100 may determine an anchor frame, determine the number of frames to be blended, and blend the frames to generate a blended frame for the digital video. In this manner, the device 100 generates blended frames for the video at half the frame rate of the camera 102.

In some other implementations, camera 102 may be configured to capture frames at higher than 60 fps (such as 120 fps or at another a frame rate at which the image frames are provided in batches from the camera 102). For example, camera 102 may be configured to capture frames at 120 fps and provide batches of four image frames to the image signal processor 112. In other examples, the frame rate associated with or the number of image frames in the batch may differ. The maximum number of image frames to be blended may be up to the number of image frames in the batch. Receiving batches of image frames may refer to receiving image frames at a defined interval or may refer to receiving image frames spaced further apart between batches than within a batch.

In the above example, the final video may be at 30 fps or another suitable frame rate less than the frame rate of the camera 102. If the frame rate of the camera 102 is 120 fps and the frame rate of the final video is to be 30 fps, the device 100 may generate one final frame of the video for every four image frames captured by the camera 102. In receiving the sequence of image frames, the device 100 is configured to receive a batch of image frames associated with one final image frame to be generated. For example, if the frame rate of the camera 102 is 120 fps and the final video's frame rate is to be 30 fps, the device 100 may receive a batch of 4 image frames associated with each final image frame to be generated for the video.

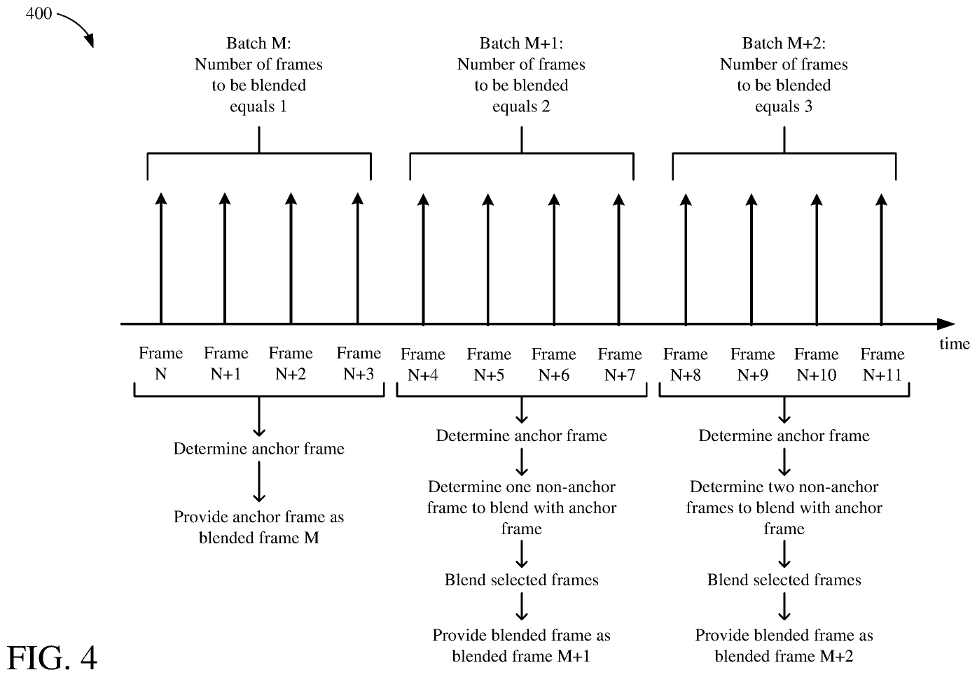

FIG. 4 is a timing diagram 400 of image frames N to N+11 of a sequence received in batches M to M+2 associated with blended image frames M to M+2 for video. Integer M approximately equals N divided by 4. While the image frames in FIG. 4 are illustrated as being received at a constant rate (with no difference in spacing between a last frame of a previous batch and a first frame of a next batch and spacing between neighboring frames in a batch). However, the spacing between batches and frames in batches may be any suitable spacing associated with readout by the camera 102 or otherwise receiving the image frames by the device 100. For example, frame N+3 and frame N+4 from different batches may be spaced further from each other than frame N+2 and frame N+3 from the same batch in the timing diagram 400.

The device 100 is to generate blended frame M for the video from batch M of frames N to N+3, blended frame M+1 for the video from batch M+1 of frames N+4 to N+7, and blended frame M+2 for the video from batch M+2 of frames N+8 to N+11. In the example, the device 100 determines that the number of frames to be blended from batch M equals 1, the number of frames to be blended from batch M+1 equals 2, and the number of frames to be blended from batch M+2 equals 3. For example, if the image quality metric is a luminance metric of an autoexposure operation, FIG. 4 may indicate that the scene lighting is decreasing as the sequence of image frames is captured. In this manner, bright light conditions with the luminance metric in a first range or greater than a first threshold may be associated with the image frames of batch M, light conditions associated with the luminance metric in a second range lower than the first range or between a first and second threshold may be associated with the image frames of batch M+1, and low light conditions associated with the luminance metric in a third range lower than the second range or less than the second threshold. In another example, if the image quality metric is a focus metric of an autofocus operation, FIG. 4 may indicate that a camera's motion is increasing as the sequence of image frames is captured. Each batch M to M+2 may be associated with a luminance metric in a different range (which may be defined by different thresholds).

As noted above, blending may include determining the anchor frame and determining which non-anchor frames to blend with the anchor frame (if the number of frames to blend is greater than 1). Similar to the above examples, the anchor frame may be determined in any suitable manner. In some implementations, the device 100 determines the most recent image frame received to be the anchor frame. For example, the anchor frame may be the last frames in a batch (such as frame N+3 of batch M, frame N+7 of batch M+1, and frame N+11 of batch M+2). In some other implementations, the device 100 may determine the anchor frame to be the image frame with the best image quality metric. For example, the device 100 may determine an image quality metric for each image frame in a batch, and the device 100 may determine the image frame in the batch associated with the best image quality metric as the anchor frame. In some other implementations, a user may preview the image frames in a batch and select the anchor frame.

The image frames in the batch to be blended with the anchor frame may be determined based on one or more of their temporal proximity to the anchor frame or their associated image quality metric. In some implementations, image frames that neighbor the anchor frame in the batch may be preferred over non-neighboring image frames to the anchor frame for blending. In addition or to the alternative of determining frames for blending based on their temporal proximity to the anchor frame, determining the non-anchor frames for blending may be based on one or more image quality metrics of the frames. For example, if the device 100 is to blend two image frames from a batch (such as batch M+1), the device 100 selects the non-anchor frame in the batch with the best image quality metric. If the device 100 is to blend three image frames from a batch (such as batch M+2), the device 100 selects the two non-anchor frames in the batch with the two best image quality metrics (disregarding the non-anchor frame in batch M+2 with the worst image quality metric). In some implementations, the device 100 may be configured to blend up to the number of frames in the batch (such as four image frames per batch for the example in FIG. 4).

For batch M (for which the number of frames to be blended equals 1), the device 100 may determine the anchor frame from the frames N to N+3, and the device 100 may provide the anchor frame as blended frame M for the video. For batch M+1 (for which the number of frames to be blended equals 2), the device 100 may determine the anchor frame from the frames N+4 to N+7, determine a non-anchor frame from the batch to be blended with the anchor frame, blend the selected anchor frame and non-anchor frame, and provide the blended frame as blended frame M+1 for the video. For batch M+2 (for which the number of frames to be blended equals 3), the device 100 may determine the anchor frame from the frames N+8 to N+11, determine two non-anchor frames from the batch to be blended with the anchor frame, blend the selected anchor frames and non-anchor frame, and provide the blended frame as blended frame M+2 for the video.

In some implementations, camera 102 may be configured for fast readout of image frames. For example, the image sensor of the camera 102 may be capable of capture and readout of four image frames within 8 milliseconds (ms) (which may be referred to as a fast shutter sensor or a fast readout sensor in a fast shutter mode). In this manner, an image frame may be readout after 2 ms of a previous image frame being readout. The image signal processor 112 may be capable of receiving an image frame from the camera 102 every 2 ms or another suitable rate corresponding to the rate at which the camera 102 provides the image frames.

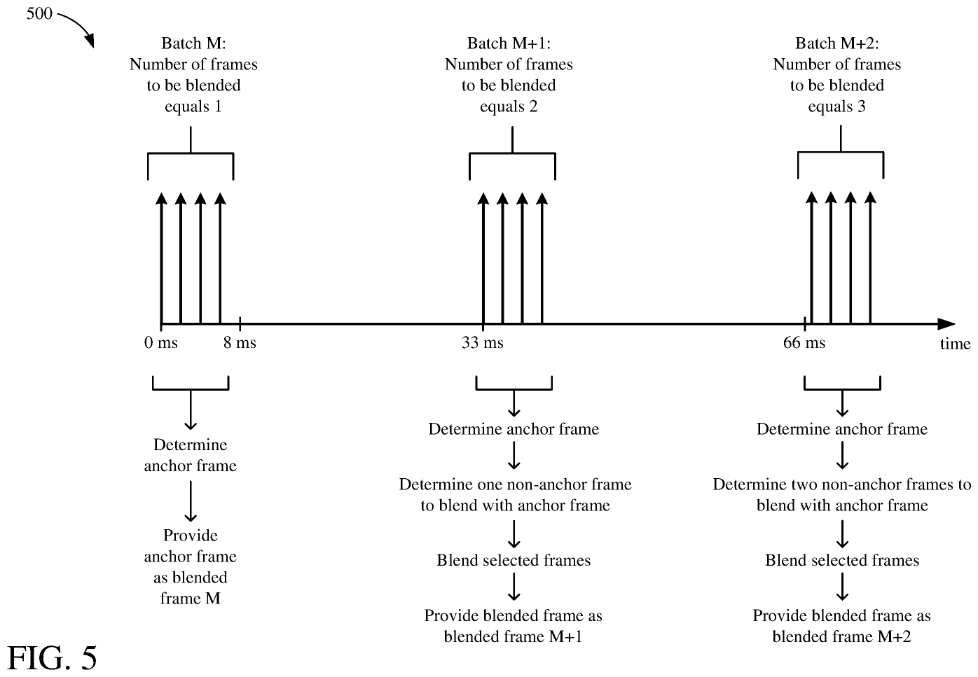

FIG. 5 is a timing diagram 500 of image frames of a sequence received from a camera including a fast readout sensor. As illustrated, the camera 102 is configured to provide four frames per batch, and the frames in the batch are provided 2 ms apart. The batches may be provided approximately every 33 ms (corresponding to a frame rate of 30 fps). In this manner, batch M of four frames is provided from approximately 0 ms to 6 ms, batch M+1 of four frames is provided from approximately 33 ms to 39 ms, and batch M+2 of four frames is provided from approximately 67 ms to 73 ms.

As illustrated (and similar to FIG. 4), the frame rate of the camera 102 may have a first frame rate greater than a second frame rate of the digital video. In this manner, generating the blended frames for the video for the sequence in FIG. 5 may be similar to the example operations described with reference to FIG. 4 above. For example, the device 100 may determine that the number of frames to be blend from batch M in FIG. 5 is 1. In this manner, the device 100 may determine the anchor frame and provide the anchor frame as blended frame M for the video. The device 100 may also determine that the number of frames to be blended from batch M+1 in FIG. 5 is 2. In this manner, the device 100 may determine the anchor frame, determine a non-anchor frame from batch M+1 to be blended with the anchor frame, blend the selected non-anchor frame to the anchor frame, and provide the blended frame as blended frame M+1 for the video. The device 100 may also determine that the number of frames to be blended from batch M+2 in FIG. 5 is 3. In this manner, the device 100 may determine the anchor frame, determine two non-anchor frames from batch M+2 to be blended with the anchor frame, blend each of the two non-anchor frames to the anchor frame, and provide the blended frame as blended frame M+2 for the video. Determining the anchor frame, determining the non-anchor frames for blending, and blending may be as described above with reference to one or more of FIGS. 2-4.

Frames captured at a higher speed (such as every 2 ms instead of every 33 ms) may be associated with shorter exposure windows. Shorter exposure windows may cause less blur associated with motion. In addition, frames captured at a higher speed are captured closer to each other in a batch. For example, referring to FIG. 4 and FIG. 5, a time difference between when frame N and frame N+3 in FIG. 4 are captured may be greater than a time difference between when the first frame and the last frame of batch M in FIG. 5 are captured. Artifacts resulting from a time difference between when frames are captured may be reduced as a result of the time difference being reduced.

Since artifacts between image frames in a batch may be reduced by reducing the time difference between image frames, determining the non-anchor frames may rely more on an image quality metric than a temporal difference between a non-anchor frame and an anchor frame. For example, for batch M+1 in FIG. 5, if the last frame is the anchor frame, the non-anchor frame to be blended to the anchor frame may be the first frame in the batch based on the first frame being associated with the best image quality metric for the first three frames in the batch (such as having the highest luminance metric or the smallest phase difference). In this manner, a non-anchor frame may be selected without reference to whether the non-anchor frame is a neighbor of the anchor frame.

For the above examples, providing a blended frame for the video may refer to providing the frame to the memory 106 for storage with the other blended frames of the video. In some implementations, the blended frames may be encoded or otherwise processed to generate a final video file. In some other implementations, the sequence of blended frames or final frames (such as after further processing of the blended frames) may be displayed for a user, transmitted to another device, or otherwise used.

While generating a blended frame for each batch is described with reference to the examples in FIG. 4 and FIG. 5, blended frames may be generated for a portion of the batches if the video's frame rate is less than the rate at which the batches are received. In some other implementations, if the video's frame rate is greater than the rate at which batches are received, the device 100 may generate multiple blended frames for the video from one batch. For example, two frames may be blended for one blended frame and the other two frames may be blended for another blended frame. In another example, two frames from the batch may be selected when a light intensity metric indicates bright light conditions.

While one image quality metric is described for many of the above examples, any combination of image quality metrics may be used. In this manner, each image quality metric may be associated with one or more thresholds and ranges, and the device 100 may determine how many image frames and/or which image frames to be blended based on a combination of the image quality metrics compared to their associated thresholds and ranges. For example, the number of image frames to be blended may be based on a light intensity metric and a sharpness metric. In addition, while an image quality metric is described as being determined for an entire frame, an image quality metric may be determined for a portion of a frame. For example, a light intensity metric may be determined for different regions of a frame. In this manner, an image frame may be associated with multiple image quality metrics of the same type (such as multiple light intensity metrics). Selecting a frame with the best image quality metric may be based on determining the best image quality metric for a frame and then selecting from the best image quality metrics for each image frame to select an image frame. In another example, selecting a frame with the best image quality metric may be based on an average, median, or other suitable combination of image quality metrics for a specific image frame. In some other implementations, blending may be performed on only a portion of an image frame. For example, the number of image frames blended may differ for different portions of a frame. In this manner, if a scene includes shadows with areas of low light and areas of bright light, regions of the image frames associated with the bright light in the scene may have fewer image frames blended, and regions of the image frames associated with the low light in the scene may have more image frames blended.

Implementation examples are described in the following numbered clauses:
1. A device for digital video processing, including:
one or more processors configured to:
   receive a sequence of image frames for a digital video;
   determine an image quality metric of a first image frame from the sequence of image frames;
   determine a number of image frames from the sequence of image frames to be blended based on the image quality metric, wherein the number of image frames includes the first image frame; and
   blend the number of image frames to generate a blended image frame of the digital video; and
a memory coupled to the one or more processors, the memory configured to store the blended image frame generated by the one or more processors.
2. The device of clause 1, wherein the image quality metric includes one of a light intensity metric or a sharpness metric.
3. The device of clause 2, wherein the light intensity metric is a luminance metric measured during an autoexposure operation of the device.
4. The device of clause 2, wherein the sharpness metric is a focus metric measured during an autofocus operation of the device.
5. The device of clause 1, wherein blending the number of image frames includes:
selecting an anchor frame from the number of image frames; and
combining each of the other image frames from the number of image frames to the anchor frame to adjust values in the anchor frame.
6. The device of clause 5, wherein selecting the anchor frame is based on a comparison of the image quality metric of each image frame in the number of image frames to one another.
7. The device of clause 5, wherein selecting the anchor frame is based on the most recent frame received.
8. The device of clause 5, wherein determining the number of image frames to be blended includes:
determining that a first number of image frames is to be blended based on the image quality metric being within a first range of image quality metrics; and
determining that a second number of image frames greater than the first number of image frames is to be blended based on the image quality metric being within a second range of image quality metrics.
9. The device of clause 8, wherein:
the sequence of image frames is at a first frame rate greater than a second frame rate of the digital video;
a first group of image frames from the sequence of image frames and including the first image frame is associated with the first image frame;
the first image frame is the anchor frame;
determining the number of image frames includes selecting the image frames from the first group of image frames to be blended; and
blending includes combining the selected image frames from the first group of image frames, wherein the blended image frame is associated with the second frame rate.
10. The device of clause 9, wherein selecting the image frames includes selecting only the first image frame, wherein the first image frame is used as the blended image frame associated with the second frame rate.
11. The device of clause 1, wherein the one or more processors are further configured to:
determine a second image quality metric of a second image frame from the sequence of image frames, wherein the second image quality metric differs from the image quality metric;
determine a second number of image frames from the sequence of image frames to be blended based on the second image quality metric, wherein:
   the second number of image frames includes the second image frame; and
   a total of the second number of image frames to be blended differs from a total of the number of image frames to be blended; and
blend the second number of image frames to generate a second blended image frame of the digital video.
12. The device of clause 11, wherein the one or more processors are further configured to provide a sequence of blended image frames of the digital video, wherein:
the sequence of blended image frames includes the blended image frame and the second blended image frame; and
the sequence of blended image frames is provided at a constant frame rate.
13. The device of clause 1, further including one or more cameras to capture the sequence of image frames.
14. The device of clause 13, wherein the one or more cameras include an image sensor configured to capture and readout four image frames from the sequence of image frames in up to eight milliseconds.
15. The device of clause 11, further including a display to display the digital video.
16. A method for digital video processing by a device, including:
receiving a sequence of image frames for a digital video;
determining an image quality metric of a first image frame from the sequence of image frames;
determining a number of image frames from the sequence of image frames to be blended based on the image quality metric, wherein the number of image frames includes the first image frame; and
blending the number of image frames to generate a blended image frame of the digital video.
17. The method of clause 16, wherein the image quality metric includes one of a light intensity metric or a sharpness metric.
18. The method of clause 17, wherein the light intensity metric is a luminance metric measured during an autoexposure operation of the device.
19. The method of clause 17, wherein the sharpness metric is a focus metric measured during an autofocus operation of the device.
20. The method of clause 16, wherein blending the number of image frames includes:
selecting an anchor frame from the number of image frames; and
combining each of the other image frames from the number of image frames to the anchor frame to adjust values in the anchor frame.
21. The method of clause 20, wherein selecting the anchor frame is based on a comparison of the image quality metric of each image frame in the number of image frames to one another.
22. The method of clause 20, wherein selecting the anchor frame is based on the most recent frame received.
23. The method of clause 20, wherein determining the number of image frames to be blended includes:
determining that a first number of image frames is to be blended based on the image quality metric being within a first range of image quality metrics; and
determining that a second number of image frames greater than the first number of image frames is to be blended based on the image quality metric being within a second range of image quality metrics.
24. The method of clause 23, wherein:
the sequence of image frames is at a first frame rate greater than a second frame rate of the digital video;
a first group of image frames from the sequence of image frames and including the first image frame is associated with the first image frame;
the first image frame is the anchor frame;
determining the number of image frames includes selecting the image frames from the first group of image frames to be blended; and
blending includes combining the selected image frames from the first group of image frames, wherein the blended image frame is associated with the second frame rate.
25. The method of clause 24, wherein selecting the image frames includes selecting only the first image frame, wherein the first image frame is used as the blended image frame associated with the second frame rate.
26. The method of clause 16, further including:
determining a second image quality metric of a second image frame from the sequence of image frames, wherein the second image quality metric differs from the image quality metric; and
determining a second number of image frames from the sequence of image frames to be blended based on the second image quality metric, wherein:
   the second number of image frames includes the second image frame; and
   a total of the second number of image frames to be blended differs from a total of the number of image frames to be blended; and
blending the second number of image frames to generate a second blended image frame of the digital video.
27. The method of clause 26, further including providing a sequence of blended image frames of the digital video, wherein:
the sequence of blended image frames includes the blended image frame and the second blended image frame; and
the sequence of blended image frames is provided at a constant frame rate.
28. The method of clause 16, wherein the sequence of image frames are captured by an image sensor configured to capture and readout four image frames from the sequence of image frames in up to eight milliseconds.
29. A non-transitory computer-readable medium storing instructions that, when executed by one or more processors of a device, cause the device to:
receive a sequence of image frames for a digital video;
determine an image quality metric of a first image frame from the sequence of image frames;
determine a number of image frames from the sequence of image frames to be blended based on the image quality metric, wherein the number of image frames includes the first image frame; and
blend the number of image frames to generate a blended image frame of the digital video.
30. The computer-readable medium of clause 29, wherein the image quality metric includes one of a light intensity metric or a sharpness metric.
31. The computer-readable medium of clause 30, wherein the light intensity metric is a luminance metric measured during an autoexposure operation of the device.
32. The computer-readable medium of clause 30, wherein the sharpness metric is a focus metric measured during an autofocus operation of the device.
33. The computer-readable medium of clause 29, wherein blending the number of image frames includes:
selecting an anchor frame from the number of image frames; and
combining each of the other image frames from the number of image frames to the anchor frame to adjust values in the anchor frame.
34. The computer-readable medium of clause 33, wherein selecting the anchor frame is based on a comparison of the image quality metric of each image frame in the number of image frames to one another.
35. The computer-readable medium of clause 33, wherein selecting the anchor frame is based on the most recent frame received.
36. The computer-readable medium of clause 33, wherein determining the number of image frames to be blended includes:
determining that a first number of image frames is to be blended based on the image quality metric being within a first range of image quality metrics; and
determining that a second number of image frames greater than the first number of image frames is to be blended based on the image quality metric being within a second range of image quality metrics.
37. The computer-readable medium of clause 36, wherein:
the sequence of image frames is at a first frame rate greater than a second frame rate of the digital video;
a first group of image frames from the sequence of image frames and including the first image frame is associated with the first image frame;
the first image frame is the anchor frame;
determining the number of image frames includes selecting the image frames from the first group of image frames to be blended; and
blending includes combining the selected image frames from the first group of image frames, wherein the blended image frame is associated with the second frame rate.
38. The computer-readable medium of clause 37, wherein selecting the image frames includes selecting only the first image frame, wherein the first image frame is used as the blended image frame associated with the second frame rate.
39. The computer-readable medium of clause 29, wherein execution of the instructions further causes the device to:
determine a second image quality metric of a second image frame from the sequence of image frames, wherein the second image quality metric differs from the image quality metric;
   determine a second number of image frames from the sequence of image frames to be blended based on the second image quality metric, wherein:
   the second number of image frames includes the second image frame; and
   a total of the second number of image frames to be blended differs from a total of the number of image frames to be blended; and
   blend the second number of image frames to generate a second blended image frame of the digital video.
40. The computer-readable medium of clause 39, wherein execution of the instructions further causes the device to provide a sequence of blended image frames of the digital video, wherein:
the sequence of blended image frames includes the blended image frame and the second blended image frame; and
   the sequence of blended image frames is provided at a constant frame rate.
41. The computer-readable medium of clause 29, wherein the sequence of image frames are captured by an image sensors configured to capture and readout four image frames from the sequence of image frames in up to eight milliseconds.
42. A device for digital video processing, including:
means for receiving a sequence of image frames for a digital video;
means for determining an image quality metric of a first image frame from the sequence of image frames;
means for determining a number of image frames from the sequence of image frames to be blended based on the image quality metric, wherein the number of image frames includes the first image frame; and
means for blending the number of image frames to generate a blended image frame of the digital video.
43. The device of clause 42, wherein the image quality metric includes one of a light intensity metric or a sharpness metric.
44. The device of clause 43, wherein the light intensity metric is a luminance metric measured during an autoexposure operation of the device.
45. The device of clause 43, wherein the sharpness metric is a focus metric measured during an autofocus operation of the device.
46. The device of clause 42, wherein blending the number of image frames includes:
selecting an anchor frame from the number of image frames; and
combining each of the other image frames from the number of image frames to the anchor frame to adjust values in the anchor frame.
47. The device of clause 46, wherein selecting the anchor frame is based on a comparison of the image quality metric of each image frame in the number of image frames to one another.
48. The device of clause 46, wherein selecting the anchor frame is based on the most recent frame received.
49. The device of clause 46, wherein determining the number of image frames to be blended includes:
determining that a first number of image frames is to be blended based on the image quality metric being within a first range of image quality metrics; and
determining that a second number of image frames greater than the first number of image frames is to be blended based on the image quality metric being within a second range of image quality metrics.
50. The device of clause 49, wherein:
the sequence of image frames is at a first frame rate greater than a second frame rate of the digital video;
a first group of image frames from the sequence of image frames and including the first image frame is associated with the first image frame;
the first image frame is the anchor frame;
determining the number of image frames includes selecting the image frames from the first group of image frames to be blended; and
blending includes combining the selected image frames from the first group of image frames, wherein the blended image frame is associated with the second frame rate.
51. The device of clause 50, wherein selecting the image frames includes selecting only the first image frame, wherein the first image frame is used as the blended image frame associated with the second frame rate.
52. The device of clause 42, further including:
means for determining a second image quality metric of a second image frame from the sequence of image frames, wherein the second image quality metric differs from the image quality metric; and
means for determining a second number of image frames from the sequence of image frames to be blended based on the second image quality metric, wherein:
   the second number of image frames includes the second image frame; and
   a total of the second number of image frames to be blended differs from a total of the number of image frames to be blended; and
means for blending the second number of image frames to generate a second blended image frame of the digital video.
53. The device of clause 52, further including means for providing a sequence of blended image frames of the digital video, wherein:
the sequence of blended image frames includes the blended image frame and the second blended image frame; and
the sequence of blended image frames is provided at a constant frame rate.
54. The device of clause 42, wherein the sequence of image frames are captured by an image sensor configured to capture and readout four image frames from the sequence of image frames in up to eight milliseconds.

Various techniques for noise processing is described herein. The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 106 in the example device 100 of FIG. 1, and also referred to as a non-transitory computer-readable medium) comprising instructions 108 that, when executed by the image signal processor 112, the processor 104, or another suitable component or combination of components, cause the device 100 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the embodiments disclosed herein may be executed by one or more processors, such as the processor 104 or the image signal processor 112 in the example device 100 of FIG. 1. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

As noted above, while the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated. Accordingly, the disclosure is not limited to the illustrated examples, and any means for performing the functionality described herein are included in aspects of the disclosure.

What is claimed is:

1. A device for digital video processing, comprising:
one or more processors configured to:
receive a sequence of image frames for a digital video;
determine an image quality metric of a first image frame from the sequence of image frames;
determine a number of image frames from the sequence of image frames to be blended based on the image quality metric, wherein the number of image frames includes the first image frame; and
blend the number of image frames to generate a blended image frame of the digital video; and
a memory coupled to the one or more processors, the memory configured to store the blended image frame generated by the one or more processors.

2. The device of claim 1, wherein the image quality metric includes one of a light intensity metric or a sharpness metric.

3. The device of claim 2, wherein the light intensity metric is a luminance metric measured during an autoexposure operation of the device.

4. The device of claim 2, wherein the sharpness metric is a focus metric measured during an autofocus operation of the device.

5. The device of claim 1, wherein blending the number of image frames includes:
selecting an anchor frame from the number of image frames; and
combining each of the other image frames from the number of image frames to the anchor frame to adjust values in the anchor frame.

6. The device of claim 5, wherein selecting the anchor frame is based on a comparison of the image quality metric of each image frame in the number of image frames to one another.

7. The device of claim 5, wherein selecting the anchor frame is based on the most recent frame received.

8. The device of claim 5, wherein determining the number of image frames to be blended includes:
determining that a first number of image frames is to be blended based on the image quality metric being within a first range of image quality metrics; and
determining that a second number of image frames greater than the first number of image frames is to be blended based on the image quality metric being within a second range of image quality metrics.

9. The device of claim 8, wherein:
the sequence of image frames is at a first frame rate greater than a second frame rate of the digital video;
a first group of image frames from the sequence of image frames and including the first image frame is associated with the first image frame;
the first image frame is the anchor frame;
determining the number of image frames includes selecting the image frames from the first group of image frames to be blended; and
blending includes combining the selected image frames from the first group of image frames, wherein the blended image frame is associated with the second frame rate.

10. The device of claim 9, wherein selecting the image frames includes selecting only the first image frame, wherein the first image frame is used as the blended image frame associated with the second frame rate.

11. The device of claim 1, wherein the one or more processors are further configured to:
determine a second image quality metric of a second image frame from the sequence of image frames, wherein the second image quality metric differs from the image quality metric;
determine a second number of image frames from the sequence of image frames to be blended based on the second image quality metric, wherein:
the second number of image frames includes the second image frame; and
a total of the second number of image frames to be blended differs from a total of the number of image frames to be blended; and
blend the second number of image frames to generate a second blended image frame of the digital video.

12. The device of claim 11, wherein the one or more processors are further configured to provide a sequence of blended image frames of the digital video, wherein:
the sequence of blended image frames includes the blended image frame and the second blended image frame; and
the sequence of blended image frames is provided at a constant frame rate.

13. The device of claim 1, further comprising one or more cameras to capture the sequence of image frames.

14. The device of claim 13, wherein the one or more cameras include an image sensor configured to capture and readout four image frames from the sequence of image frames in up to eight milliseconds.

15. The device of claim 11, further comprising a display to display the digital video.

16. A method for digital video processing by a device, comprising:
receiving a sequence of image frames for a digital video;
determining an image quality metric of a first image frame from the sequence of image frames;
determining a number of image frames from the sequence of image frames to be blended based on the image quality metric, wherein the number of image frames includes the first image frame; and
blending the number of image frames to generate a blended image frame of the digital video.

17. The method of claim 16, wherein the image quality metric includes one of a light intensity metric or a sharpness metric.

18. The method of claim 17, wherein the light intensity metric is a luminance metric measured during an autoexposure operation of the device.

19. The method of claim 17, wherein the sharpness metric is a focus metric measured during an autofocus operation of the device.

20. The method of claim 16, wherein blending the number of image frames includes:
selecting an anchor frame from the number of image frames; and
combining each of the other image frames from the number of image frames to the anchor frame to adjust values in the anchor frame.

21. The method of claim 20, wherein selecting the anchor frame is based on a comparison of the image quality metric of each image frame in the number of image frames to one another.

22. The method of claim 20, wherein selecting the anchor frame is based on the most recent frame received.

23. The method of claim 20, wherein determining the number of image frames to be blended includes:
determining that a first number of image frames is to be blended based on the image quality metric being within a first range of image quality metrics; and
determining that a second number of image frames greater than the first number of image frames is to be blended based on the image quality metric being within a second range of image quality metrics.

24. The method of claim 23, wherein:
the sequence of image frames is at a first frame rate greater than a second frame rate of the digital video;
a first group of image frames from the sequence of image frames and including the first image frame is associated with the first image frame;
the first image frame is the anchor frame;
determining the number of image frames includes selecting the image frames from the first group of image frames to be blended; and
blending includes combining the selected image frames from the first group of image frames, wherein the blended image frame is associated with the second frame rate.

25. The method of claim 24, wherein selecting the image frames includes selecting only the first image frame, wherein the first image frame is used as the blended image frame associated with the second frame rate.

26. The method of claim 16, further comprising:
determining a second image quality metric of a second image frame from the sequence of image frames, wherein the second image quality metric differs from the image quality metric; and
determining a second number of image frames from the sequence of image frames to be blended based on the second image quality metric, wherein:
the second number of image frames includes the second image frame; and
a total of the second number of image frames to be blended differs from a total of the number of image frames to be blended; and
blending the second number of image frames to generate a second blended image frame of the digital video.

27. The method of claim 26, further comprising providing a sequence of blended image frames of the digital video, wherein:
the sequence of blended image frames includes the blended image frame and the second blended image frame; and
the sequence of blended image frames is provided at a constant frame rate.

28. The method of claim 16, wherein the sequence of image frames are captured by an image sensor configured to capture and readout four image frames from the sequence of image frames in up to eight milliseconds.

29. A non-transitory computer-readable medium storing instructions that, when executed by one or more processors of a device, cause the device to:
receive a sequence of image frames for a digital video;
determine an image quality metric of a first image frame from the sequence of image frames;
determine a number of image frames from the sequence of image frames to be blended based on the image quality metric, wherein the number of image frames includes the first image frame; and
blend the number of image frames to generate a blended image frame of the digital video.

30. The computer-readable medium of claim 29, wherein blending the number of image frames includes:
selecting an anchor frame from the number of image frames; and
combining each of the other image frames from the number of image frames to the anchor frame to adjust values in the anchor frame.
